(19) United States
(12) Patent Application Publication
(10) Pub. No.: US 2007/0285434 A1
(43) Pub. Date: Dec. 13, 2007

(54) Hue adjustor and method for adjusting hues for specific colors in an image

(76) Inventors: Hung-Shih Lin, Hsinhua (TW); Wei-Jen Ko, Hsinhua (TW)

Correspondence Address: J.C. Patents, Suite 250, 4 Venture, Irvine, CA, 92618, US

(21) Appl. No.: 11/451,649

(22) Filed: Jun. 12, 2006

(51) Int. Cl. G09G 5/02

(52) U.S. Cl. 345/600

(57) ABSTRACT

A hue adjustor and method for adjusting hues for specific colors in an image are provided. The hue adjustor includes a CORDIC unit (coordinated rotation digital computer unit), a color partition operation unit and a hue rotation unit. The color partition operation unit is coupled to the CORDIC unit and used to compute a new hue angle corresponding to a chrominance signal when falling in an adjustment area that is generated based on a control signal. The hue rotation unit is coupled to the color partition operation unit and used to rotate the chrominance signal by the new hue angle.

### BACKGROUND OF THE INVENTION

1. Field of Invention

The present invention relates to a hue adjustor and method, and particularly to a hue adjustor and method suitable for adjusting hues for specified colors in an image.

2. Description of Related Art

Conventionally, hue adjustor and method for adjusting hues for colors in an image is implemented in RGB color space, where R refers to red, G refers to green and B refers to blue. In the conventional method, an RGB image signal is converted into a brightness signal (Y) and a chrominance signal (Cb/Cr) where the chrominance signal (Cb/Cr) is a complex signal which includes a real component Cb and an imaginary component Cr. By rotating the angle of the chrominance signal (Cb/Cr), i.e. by rotating the hue angle, the corresponding color can be adjusted. In the conventional method, the chrominance signal (Cb/Cr) for every color within the image is rotated by the same angle.

However, the conventional method for adjusting hues for colors in an image is not able to adjust specific colors based on user preferences. For example, a user may want to enhance some of the colors, such as the blue sky, green leaves, setting sun and so on, to make the image more vivid and colorful.

### SUMMARY OF THE INVENTION

Therefore, the present invention provides a hue adjustor and method for adjusting hues for specific colors without affecting other colors.

The invention provides a hue adjustor. The hue adjustor comprises: a CORDIC unit, computing a first hue angle corresponding to a first chrominance signal; a color partition operation unit, coupled to the CORDIC unit, forming an adjustment area based on a control signal to output a second hue angle corresponding to the first hue angle when the first chrominance signal falls in the adjustment area; and a hue rotation unit, coupled to the color partition operation unit, rotating the first chrominance signal by the second hue angle to output a second chrominance signal of the input image signal.

Further, the invention provides a method for adjusting hues in an image. In the method, a first hue angle corresponding to a first chrominance signal is computed. An adjustment area is formed based on a control signal. A second hue angle corresponding to the first hue angle is generated when the first chrominance signal falls in the adjustment area. The first chrominance signal is rotate by the second hue angle to output a second chrominance signal.

Further, the invention provides a hue adjustor, comprising: a first image conversion unit, receiving and converting an input image signal into a first hue angle and other component; a color partition operation unit, coupled to the first image conversion unit, forming an adjustment area based on a control signal to output a second hue angle corresponding to the first hue angle when the first hue angle falls in the adjustment area; a hue angle processing unit, coupled to the color partition operation unit, processing the first and second hue angles to obtain a third hue angle; and a second image conversion unit, coupled to the hue angle processing unit, converting the third hue angle and the other component into an output image signal.

Further, the invention provides a method for adjusting hues in an image, comprising: converting an input image signal into a first hue angle and other component; forming an adjustment area based on a control signal; generating a second hue angle corresponding to the first hue angle when the first hue angle falls in the adjustment area; obtaining a third hue angle based on the first and second hue angles; and converting the third hue angle and the other component into an output image signal.

Still further, the invention provides a color partition operation unit, receiving a first hue angle and a control signal to output a second hue angle. The color partition operation unit comprises: a partition unit, generating a plurality of color areas with a plurality of reference color axes, selecting and rotating one or more reference color axes to be rotated based on the control signal, and defining the color areas next to the reference color axes to be rotated as an adjustment area, the rotated reference color axes falling in the adjustment area; and an operation unit, coupled to the partition unit, performing operations on the first hue angle when falling in the adjustment area to obtain the second hue angle.

Further, the invention provides a method for adjusting colors in an input image, comprising: receiving a first hue angle converted from the input image and a control signal; generating a plurality of color areas with a plurality of reference color axes; selecting and rotating one or more reference color axes to be rotated based on the control signal; choosing one or more color areas next to the reference color axes to be rotated as an adjustment area, the rotated reference color axes falling in the adjustment area; and performing operations on the first hue angle when falling in the adjustment area to obtain a second hue angle.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a block diagram of a hue adjustor according to a first embodiment of the present invention.

FIG. 1B is a block diagram of a hue adjustor according to a second embodiment of the present invention.

FIG. 2A is a diagram showing a color gamut partitioned by six reference color axes for the hue adjustor of FIG. 1A.

FIG. 2B is a diagram showing a color gamut partitioned by six reference color axes for the hue adjustor of FIG. 1B.

FIG. 3A is a flowchart of the method for adjusting hues according to the first embodiment of the present invention.

FIG. 3B is a flowchart of the method for adjusting hues according to the second embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

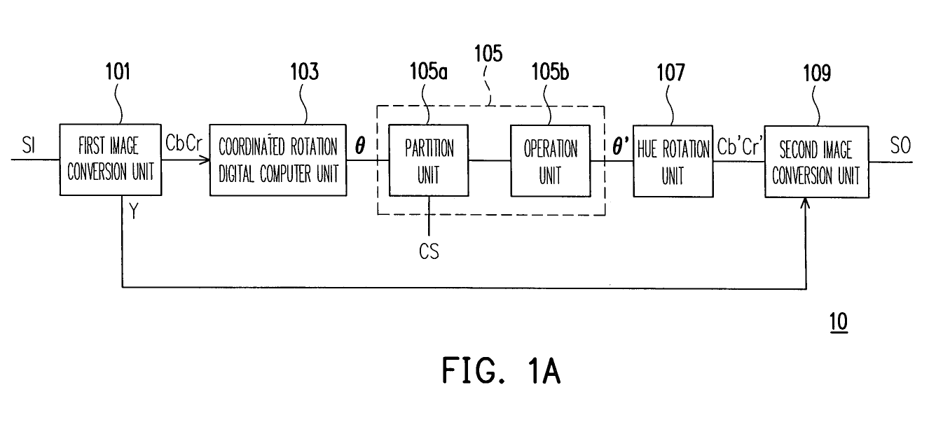

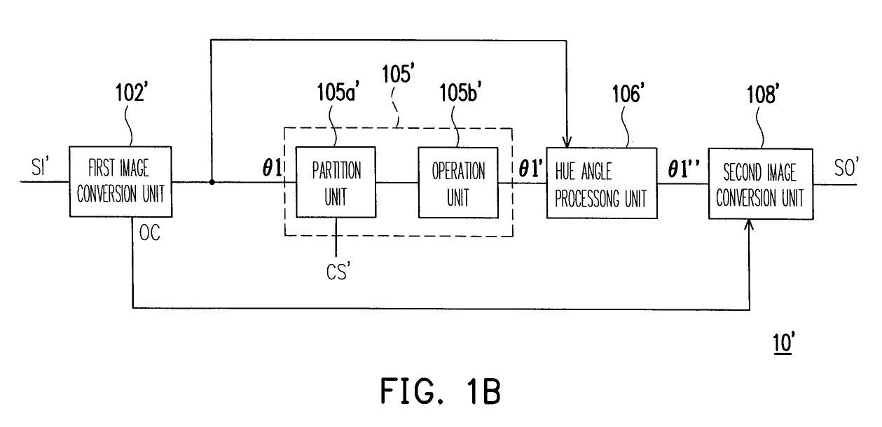

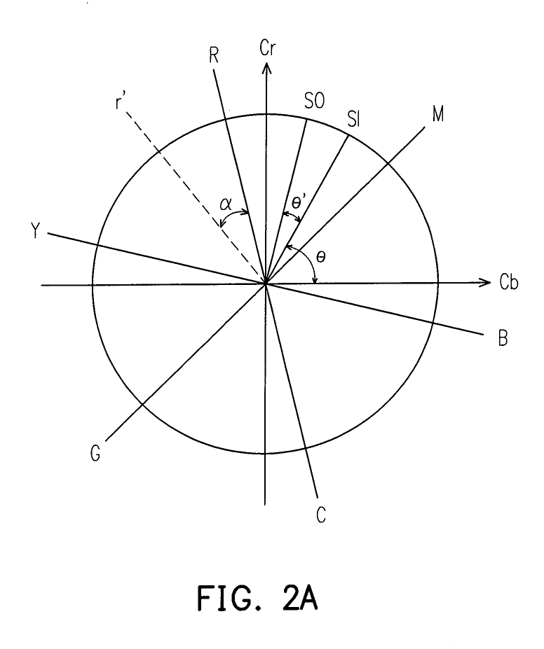

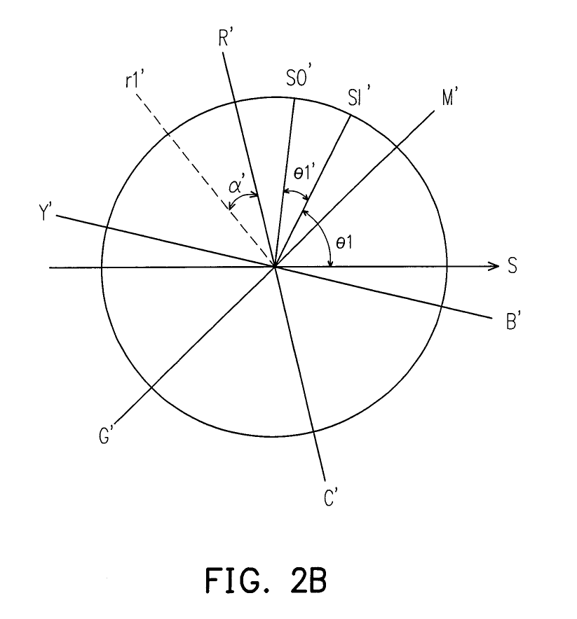

FIG. 1A is a block diagram of a hue adjustor according to a first embodiment of the present invention. FIG. 2A is a diagram showing a color gamut partitioned by six reference color axes for the hue adjustor of FIG. 1A. Referring to FIGS. 1A and 2A, the hue adjustor 10 for adjusting hues for specific colors includes a first image conversion unit 101, a CORDIC unit (coordinated rotation digital computer unit) 103, a color partition operation unit 105, a hue rotation unit 107 and a second image conversion unit 109.

The first image conversion unit 101 is used to receive an input image signal SI, which can be an RGB image signal, and convert the RGB image signal SI into a brightness signal Y and a first chrominance signal Cb/Cr, where the first chrominance signal Cb/Cr is a complex signal on a color gamut formed by a real component Cb and an imaginary component Cr.

The CORDIC unit 103 is used to compute the first hue angle θ corresponding to the first chrominance signal Cb/Cr as tan⁻¹(Cr/Cb). The color partition operation unit 105 is coupled to the CORDIC unit 103 and generates a second hue angle θ′ corresponding to the first hue angle θ when the first chrominance signal falls in an adjustment area that is generated based on a control signal CS.

The color partition operation unit 105 includes a partition unit 105a and an operation unit 105b. The partition unit 105a is coupled to the CORDIC unit 103 and used to generate N color areas on the color gamut with N reference color axes, where N is a positive integer, and to select one or more color areas as the adjustment area that is based on the control signal CS. For example, six reference color axes red (R), green (G), blue (B), cyan (C), yellow (Y) and magenta (M) may be used to generate six color areas MB, BC, CG, GY, YR and RM on the color gamut.

Based on the control signal CS, one of the reference color axis, for example, the reference color axis R, is selected to be rotated. Further, based on the reference color axis that is selected to be rotated, the color areas next to the reference color axis, for example, two color areas YR and RM, are defined as the adjustment area.

The operation unit 105b is coupled to the partition unit 105a and used to process the first chrominance signal Cb/Cr when falling in the adjustment area to output a second hue angle θ′ corresponding to the first hue angle θ. The second hue angle θ′ is obtained by the operation unit 105b using, for example, linear interpolation, linear extrapolation, quadratic equation, cubic equation or any combination thereof.

The hue rotation unit 107 is coupled to the color partition operation unit 105 to rotate the first chrominance signal Cb/Cr by the second hue angle θ′ and to output a second chrominance signal Cb′/Cr′.

The second image conversion unit 109 is coupled to the hue rotation unit 107 to convert the brightness signal Y obtained by the first image conversion unit 101 and the second chrominance signal Cb′/Cr′ into an output image signal SO, which can be an RGB signal.

Note that, in the embodiment, if the input image signal SI is a YCbCr image signal, both the first image conversion unit 101 and the second image conversion unit 109 can be skipped.

In the embodiment, once the hue adjustor 10 receives the input image signal SI, the first image conversion unit 101 converts the input image signal SI into the brightness signal Y and the first chrominance signal Cb/Cr. The CORDIC unit 103 can accord the first chrominance signal Cb/Cr to compute the corresponding first hue angle θ and to output the first hue angle θ to the partition unit 105a.

When a user wants to adjust a specific color, for example, the red color (but not limited to a single color), the partition unit 105a can receive a control signal CS, and, based on the control signal CS, select the reference color axis and rotate the reference color axis R by an angle a to make a new reference axis r′ and to generate an adjustment area MY.

In this example, the adjustment area MY is formed by the two color areas next to the reference color axis R, i.e., the color area MR (between the reference color axis M and the reference color axis R) and the color area RY (between the reference color axis R and the reference color axis Y). The operation unit 105b performs operations on the first hue angles θ when falling in the adjustment area MY to output the second hue angle θ′.

The second hue angle θ′ are computed by, for example, the following linear interpolation equations (1) and (2):

θ′=[θ/Angle(MR)]·Angle(Mr′) when the first hue angle θ falls in the color area MR (1)

θ′=[θ/Angle(RY)]·Angle(r′Y) when the first hue angle θ falls in the color area RY (2)

where θ and θ′ are the first and second hue angles corresponding to the first chrominance signal Cb/Cr, Angle(MR) is the included angle between the reference color axis M and the reference color axis R, Angle(Mr′) is the included angle between the reference color axis M and the reference color axis r′, Angle(RY) is the included angle between the reference color axis R and the reference color axis Y and Angle(r′Y) is the included angle between the reference color axis r′ and the reference color axis Y.

When the first chrominance signal Cb/Cr falls in the color area MR between the reference color axis M and the reference color axis R, the second hue angle θ is computed by the equation (1); when the first chrominance signal Cb/Cr falls in the color area YR between the reference color axis Y and the reference color axis R, the second hue angle θ′ is computed by the equation (2). Furthermore, linear extrapolation, quadratic equations, cubic equations or any combination thereof can be also used to obtain the second hue angle θ′.

After that, the hue rotation unit 107 can rotate the first chrominance signal Cb/Cr when falling in the adjustment area by the second hue angle θ′ to output the second chrominance signal Cb′/Cr′, as well known in the field. In the embodiment, the hue rotation unit 107 can obtain the second chrominance signal Cb′/Cr′ based on the following equations (3) and (4):

Cb′=Cb·sin θ′+Cr·cos θ′ (3)

Cr′=Cr·sin θ′+Cb·cos θ′ (4)

The second image conversion unit 109 can then convert the brightness signal Y and the second chrominance signal Cb′/Cr′ into an output image signal SO which can be an RGB signal for output.

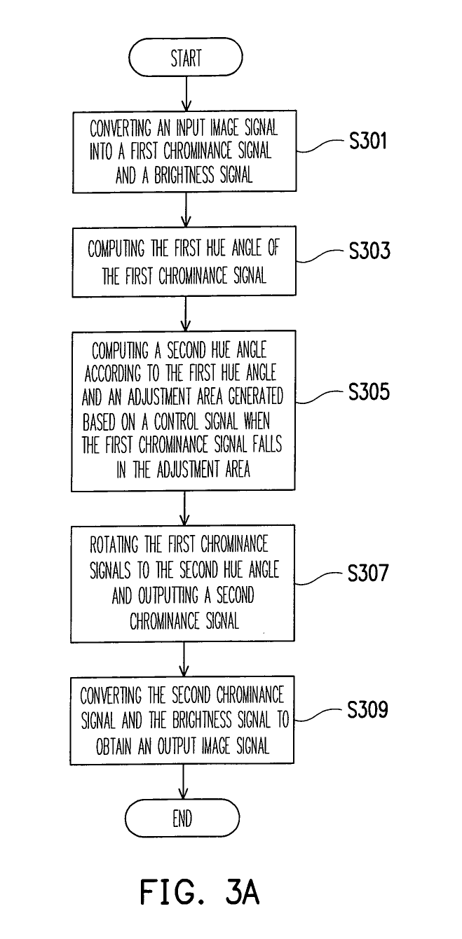

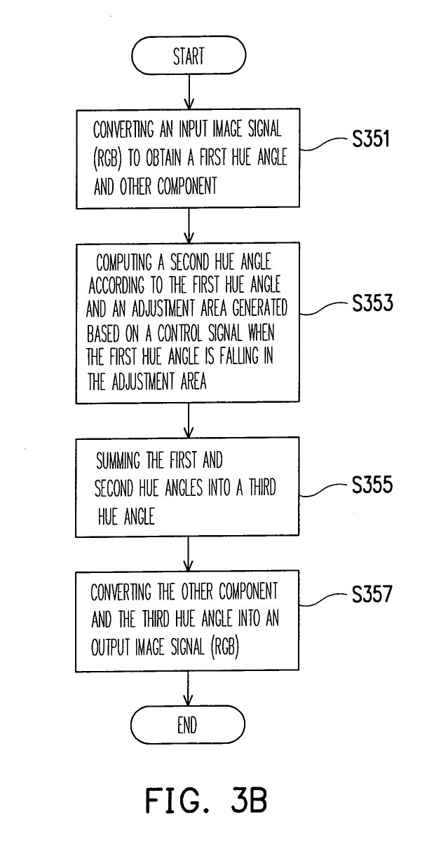

FIG. 3A is a flowchart of a method for adjusting hues for specific colors in an image according to the first embodiment of the present invention. First, in step S301, an input image signal (which can be a RGB signal) is converted into a first chrominance signal and a brightness signal; next in step S303, a first hue angle corresponding to the first chrominance signal is computed; afterwards in step S305, a second hue angle corresponding to the first hue angle is computed according to an adjustment area that is generated based on a control signal when the first chrominance signal falls in the adjustment area; further in step S307, the first chrominance signal is rotated by the second hue angle to output the second chrominance signals; and in step S309, the second chrominance signal and the brightness signal are converted into an output image signal (which can be a RGB signal).

In the first embodiment, the second hue angle in step S305 is computed, for example, by using linear interpolation, linear extrapolation, quadratic equation, cubic equation or any combination thereof; and the adjustment area in step S305 is determined by, based on a reference color axis that is selected to be rotated, choosing the color areas next to the reference color axis selected to be rotated.

FIG. 1B is a block diagram of a hue adjustor 10′ for adjusting hues for specific colors according to a second embodiment of the present invention. FIG. 2B is a diagram showing a color gamut partitioned by six reference color axes for the hue adjustor of FIG. 1B. Referring to FIGS. 1B and 2B, the hue adjustor 10′ includes a first image conversion unit 102′, a color partition operation unit 105′, a hue angle processing unit 106′ and a second image conversion unit 108′.

The first image conversion unit 102′ is used to receive an input image signal SI′, which can be an RGB image signal, and convert the RGB image signal SI′ into a first hue angle θ1 and other component OC.

The color partition operation unit 105′ is coupled to the first image conversion unit 102′ and generates a second hue angle θ1′ corresponding to the first hue angle θ1 when the first hue angle θ1 falls in an adjustment area that is generated based on a control signal CS′.

The color partition operation unit 105′ includes a partition unit 105a′ and an operation unit 105b′. The partition unit 105a′ is coupled to the first image conversion unit 102′ and used to generate X color areas on the color gamut with X reference color axes, where X is a positive integer, and to select one or more color areas as the adjustment area that is based on the control signal CS′. For example, in case of X=6, six reference color axes red (R′), green (G′), blue (B′), cyan (C′), yellow (Y′) and magenta (M′) may be used to generate six color areas M′B′, B′C′, C′G′, G′Y′, Y′R′ and R′M′ on the color gamut.

Based on the control signal CS′, one of the reference color axis, for example, the reference color axis R′, can be selected to be rotated. Further, based on the reference color axis that is selected to be rotated, the color areas next to the reference color axis, for example, two color areas Y′R′ and R′M′, are defined as the adjustment area.

The operation unit 105b′ is coupled to the partition unit 105a′ and used to process the first hue angle θ1 when falling in the adjustment area to output a second hue angle θ1′ corresponding to the first hue angle θ1. The second hue angle θ1′ is obtained by the operation unit 105b′ using, for example, linear interpolation, linear extrapolation, quadratic equation, cubic equation or any combination thereof.

The hue angle processing unit 106′ is coupled to the color partition operation unit 105′ for generating a third hue angle θ1″ based on the first hue angle θ1 and the second hue angle θ1′, for example, by adding the first hue angle θ1 and the second hue angle θ1′.

The second image conversion unit 108′ is coupled to the hue angle processing unit 106′ to convert the third hue angle θ1″ and other component OC into an output image signal SO′, which can be an RGB signal.

In the second embodiment, when the hue adjustor 10′ receives the input image signal SI′, the first image conversion unit 102′ converts the input image signal SI′ into the first hue angle θ and other component OC.

When a user wants to adjust a specific color, for example, the red color (but not limited to a single color), the partition unit 105a′ receives a control signal CS′, and, based on the control signal CS′, selects the reference color axis and rotates the reference color axis R′ by an angle α′ to make a new reference axis r1′ and to generate an adjustment area M′Y′.

In this example, the adjustment area M′Y′ is formed by the two color areas next to the reference color axis R′, i.e., the color area M′R′ (between the reference color axis M′ and the reference color axis R′) and the color area R′Y′ (between the reference color axis R′ and the reference color axis Y′). The operation unit 105b′ performs operations on the first hue angle θ1 when falling in the adjustment area M′Y′ to output the second hue angle θ1′.

The second hue angle θ1′ are computed by, for example, the following linear interpolation equations (3) and (4):

θ1′=[θ1/Angle(M′R′)]·Angle(M′r1′) when the first hue angle θ1 falls in the color area M′R′ (5)

θ1′=[θ1/Angle(R′Y′)]·Angle(r1′Y′) when the first hue angle θ1 falls in the color area R′Y′ (6)

where θ1 and θ1′ are the first and second hue angles, Angle(M′R′) is the included angle between the reference color axis M′ and the reference color axis R′, Angle(M′r1′) is the included angle between the reference color axis M′ and the reference color axis r1′, Angle(R′Y′) is the included angle between the reference color axis R′ and the reference color axis Y′ and Angle(r1′Y′) is the included angle between the reference color axis r1′ and the reference color axis Y′.

When the first hue angle θ1 falls in the color area M′R′ between the reference color axis M′ and the reference color axis R′, the second hue angle θ1′ is computed by the equation (5). Or, when the first hue angle θ1 falls in the color area Y′R′ between the reference color axis Y′ and the reference color axis R′, the second hue angle θ1′ is computed by the equation (6). Furthermore, linear extrapolation, quadratic equations, cubic equations or any combination thereof can be also used to obtain the second hue angle θ1′.

After that, the hue angle processing unit 106′ generates the third hue angle θ1″, for example but not limited to, by summing the first and second hue angles θ1 and θ1′, i.e. θ1″=θ1+θ1′.

The second image conversion unit 108′ can then convert the third hue angle θ1″ and other component OC into the output image signal SO′ which can be an RGB signal for output.

FIG. 3B is a flowchart of a method for adjusting hues for specific colors in an image according to the second embodiment of the present invention. First, in step S351, an input image signal (which can be a RGB signal) is converted into a first hue angle and other component. In step S353, a second hue angle corresponding to the first hue angle is computed according to an adjustment area that is generated based on a control signal when the first hue angle is falling in the adjustment area. In step S355, the first and second hue angles are summed into a third hue angle. In step S357, the third hue angle and other component are converted into an output image signal (which can be a RGB signal).

The second hue angle in step S353 is computed, for example, by using linear interpolation, linear extrapolation, quadratic equation, cubic equation or any combination thereof. The adjustment area in step S353 is determined by, based on a reference color axis that is selected to be rotated, choosing the color areas next to the reference color axis selected to be rotated.

In summary, the embodiments of the present invention provide a hue adjustor and method for adjusting hues for specific colors in an image, which at least has the following advantages. A user is able to adjust the hue angles for specified colors in an image without affecting other colors. The user can determine the number of the color areas partitioned for selection and adjustment. Either a single or several reference colors can be selected to be rotated, which is different from the conventional method where all colors in an image are rotated by the same angle.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A hue adjustor, comprising:
a CORDIC unit, computing a first hue angle corresponding to a first chrominance signal;
a color partition operation unit, coupled to the CORDIC unit, forming an adjustment area based on a control signal and outputting a second hue angle corresponding to the first hue angle when the first chrominance signal falls in the adjustment area; and
a hue rotation unit, coupled to the color partition operation unit, rotating the first chrominance signal by the second hue angle to output a second chrominance signal of the input image signal.

2. The hue adjustor as recited in claim 1, wherein the hue adjustor further comprises a first image conversion unit for receiving an input image signal and converting the received input image signal into the first chrominance signal and a brightness signal.

3. The hue adjustor as recited in claim 2, wherein the hue adjustor further comprises a second image conversion unit coupled to the hue rotation unit for converting the second chrominance signal and the brightness signal into an output image signal.

4. The hue adjustor as recited in claim 3, wherein the input image signal and the output image signal are RGB signals.

5. The hue adjustor as recited in claim 1, wherein the color partition operation unit comprises:
a partition unit, coupled to the CORDIC unit, generating N color areas with N reference color axes, and selecting one or more color areas as the adjustment area based on the control signal, wherein N is a positive integer; and
an operation unit, coupled to the partition unit, performing operations on the first chrominance signal when falling in the adjustment area to obtain the second hue angle.

6. The hue adjustor as recited in claim 5, wherein the operation unit uses linear interpolation, linear extrapolation, quadratic equation, cubic equation or any combination thereof to obtain the second hue angle.

7. The hue adjustor as recited in claim 6, wherein the partition unit selects two color areas at two sides of a selected reference color axis as the adjustment area, and the operation unit uses linear interpolation to obtain the second hue angle, which is expressed as:
θ′=[θ/Angle(MR)]·Angle(Mr′) when the first hue angle falls in one color area at one side of the selected reference color axis; and
θ′=[θ/Angle(RY)]·Angle(r′Y) when the first hue angle falls in the other color area at the other side of the selected reference color axis,
where θ and θ′ are the first and second hue angles corresponding to the first chrominance signal Cb/Cr, R is the reference color axis selected to be rotated and r′ is the rotated reference color axis, M and Y are the reference color axes at the two sides of the reference color axis to be rotated, Angle(MR) is the included angle between the reference color axis M and the reference color axis R, Angle(Mr′) is the included angle between the reference color axis M and the reference color axis r′, Angle(RY) is the included angle between the reference color axis R and the reference color axis Y and Angle(r′Y) is the included angle between the reference color axis r′ and the reference color axis Y.

8. The hue adjustor as recited in claim 7, wherein the hue rotation unit rotates the first chrominance signal to obtain the second chrominance signal by the following equations:
Cb′=Cb·sin θ′+Cr·cos θ′;
and
Cr′=Cr·sin θ′−Cb·cos θ′,
wherein Cb/Cr and Cb′/Cr′ are the first and second chrominance signals.

9. A method for adjusting hues in an image, comprising:
computing a first hue angle corresponding to a first chrominance signal;
forming an adjustment area based on a control signal;
generating a second hue angle corresponding to the first hue angle when the first chrominance signal falls in the adjustment area; and
rotating the first chrominance signal by the second hue angle to output a second chrominance signal.

10. The method for adjusting hues as recited in claim 9, further comprising converting an input image signal into the first chrominance signal and a brightness signal.

11. The method for adjusting hues as recited in claim 9, further comprising converting the second chrominance signals and the bright signal into an output image signal.

12. The method for adjusting hues as recited in claim 9, wherein the step for generating the adjustment area comprises:
generating a plurality of color areas by a plurality of reference color axes;
selecting a reference color axis to be rotated based on to the control signal; and
choosing one or more color areas next to a reference color axis selected to be rotated as the adjustment area.

13. The method for adjusting hues as recited in claim 11, wherein the input image signal and the output image signal are RGB signals.

14. The method for adjusting hues as recited in claim 9, wherein the step for generating the second hue angle comprises: using linear interpolation, linear extrapolation, quadratic equation, cubic equation or any combination thereof to obtain the second hue angle.

15. The method for adjusting hues as recited in claim 14, wherein the step for forming the adjustment area comprises choosing two color areas at two sides of the reference color axis selected to be rotated, and the step for generating the second hue angle uses linear extrapolation expressed as:
θ′=[θ/Angle(MR)]·Angle(Mr′) when the first hue angle falls in one color area at one side of the selected reference color axis; and
θ′=[θ/Angle(RY)]·Angle(r′Y) when the first hue angle falls in the other color area at the other side of the selected reference color axis,
where θ and θ′ are the first and second hue angles of the first chrominance signal Cb/Cr, R is the reference color axis selected to be rotated, r′ is the rotated reference color axis, M and Y are the reference color axes at the two sides of the reference color axis selected to be rotated, Angle(Mr′) is the included angle between the reference color axis M and the reference color axis r′, Angle(RY) is the included angle between the reference color axis R and the reference color axis Y and Angle(r′Y) is the included angle between the reference color axis r′ and the reference color axis Y.

16. The method for adjusting hues as recited in claim 15, wherein the step of outputting the second chrominance signal is expressed as:
Cb′=Cb·sin θ′+Cr·cos θ′;
and
Cr′=Cr·sin θ′−Cb·cos θ′,
where Cb/Cr is the first chrominance signal and Cb′/Cr′ is the second chrominance signal.

17. A hue adjustor, comprising:
a first image conversion unit, receiving and converting an input image signal into a first hue angle and other component;
a color partition operation unit, coupled to the first image conversion unit, forming an adjustment area based on a control signal and outputting a second hue angle corresponding to the first hue angle when the first hue angle falls in the adjustment area;
a hue angle processing unit, coupled to the color partition operation unit, processing the first and second hue angles to obtain a third hue angle; and
a second image conversion unit, coupled to the hue angle processing unit, converting the third hue angle and the other component into an output image signal.

18. The hue adjustor as recited in claim 17, wherein the input image signal and the output image signal are RGB signals.

19. The hue adjustor as recited in claim 17, wherein the color partition operation unit comprises:
a partition unit, coupled to the first image conversion unit, generating N color areas with N reference color axes, and selecting one or more color areas as the adjustment area based on the control signal, wherein N is a positive integer; and
an operation unit, coupled to the partition unit, performing operations on the first hue angle when falling in the adjustment area to obtain the second hue angle.

20. The hue adjustor as recited in claim 19, wherein the operation unit uses linear interpolation, linear extrapolation, quadratic equation, cubic equation or any combination thereof to obtain the second hue angle.

21. The hue adjustor as recited in claim 20, wherein the partition unit selects two color areas at two sides of a selected reference color axis as the adjustment area based on the control signal, and the operation unit uses linear interpolation to obtain the second hue angle, which is expressed as:
θ1′=[θ1/Angle(M′R′)]·Angle(M′r1′) when the first hue angle falls in one color area at one side of the selected reference color axis; and
θ1′=[θ1/Angle(R′Y′)]·Angle(r1′Y) when the first hue angle falls in the other color area at the other side of the selected reference color axis;
where θ1 and θ1′ are the first and second hue angles, R′ is the reference color axis selected to be rotated, r1′ is the rotated reference color axis, M′ and Y′ are the reference color axes at the two sides of the reference color axis selected to be rotated, Angle(M′r1′) is the included angle between the reference color axis M′ and the reference color axis r1′, Angle(R′Y′) is the included angle between the reference color axis R′ and the reference color axis Y′ and Angle(r1′Y′) is the included angle between the reference color axis r1′ and the reference color axis Y′.

22. The hue adjustor as recited in claim 17, wherein the hue angle processing unit sums the first and second hue angles into the third hue angle.

23. A method for adjusting hues in an image, comprising:
converting an input image signal into a first hue angle and other component;
forming an adjustment area based on a control signal;
generating a second hue angle corresponding to the first hue angle when the first hue angle falls in the adjustment area;
obtaining a third hue angle based on the first and second hue angles; and
converting the third hue angle and the other component into an output image signal.

24. The method for adjusting hues as recited in claim 23, wherein the step for generating the adjustment area comprises:
generating a plurality of color areas by a plurality of reference color axes;
selecting a reference color axis to be rotated based on to the control signal; and
choosing one or more color areas next to the reference color axis selected to be rotated as the adjustment area.

25. The method for adjusting hues as recited in claim 23, wherein the input image signal and the output image signal are RGB signals.

26. The method for adjusting hues as recited in claim 23, wherein the step for generating the second hue angle comprises: using linear interpolation, linear extrapolation, quadratic equation, cubic equation or any combination thereof to obtain the second hue angle.

27. The method for adjusting hues as recited in claim 26, wherein step for forming the adjustment area comprises choosing two color areas at two sides of a reference color axis selected to be rotated, and the step for generating the second hue angle uses linear extrapolation expressed as:
θ1′=[θ1/Angle(M′R′)]·Angle(M′r1′) when the first hue angle falls in one color area at one side of the selected reference color axis; and
θ1′=[θ1/Angle(R′Y′)]·Angle(r1′Y) when the first hue angle falls in the other color area at the other side of the selected reference color axis;
where θ1 and θ1′ are the first and second hue angles, R′ is the reference color axis selected to be rotated, r1′ is the rotated reference color axis, M′ and Y′ are the two reference color axes at the two sides of the reference color axis selected to be rotated, Angle(M′r1′) is the included angle between the reference color axis M′ and the reference color axis r1′, Angle(R′Y′) is the included angle between the reference color axis R′ and the reference color axis Y′ and Angle(r1′Y′) is the included angle between the reference color axis r1′ and the reference color axis Y′.

28. The hue adjustor as recited in claim 23, wherein the step of obtaining the third hue angle based on the first and second hue angles includes a step of:
summing the first and second hue angles into the third hue angle.

29. A color partition operation unit, receiving a first hue angle and a control signal to output a second hue angle, the color partition operation unit comprising:
a partition unit, generating a plurality of color areas with a plurality of reference color axes, selecting one or more reference color axes to be rotated based on the control signal, and defining the color areas next to the reference color axes to be rotated as an adjustment area, the rotated reference color axes falling in the adjustment area; and
an operation unit, coupled to the partition unit, performing operations on the first hue angle when falling in the adjustment area to obtain the second hue angle.

30. The color partition operation unit as recited in claim 29, wherein the operation unit uses linear interpolation, linear extrapolation, quadratic equation, cubic equation or any combination thereof to obtain the second hue angle.

31. The color partition operation unit as recited in claim 30, wherein the partition unit selects two color areas at two sides of each selected reference color axis as the adjustment area, and the operation unit uses linear interpolation to obtain the second hue angle, which is expressed as:
θ′=[θ/Angle(MR)]·Angle(Mr′) when the first hue angle falls in one color area at one side of the selected reference color axis; and
θ′=[θ/Angle(RY)]·Angle(r′Y) when the first hue angle falls in the other color area at the other side of the selected reference color axis,
where θ and θ′ are the first and second hue angles of the first chrominance signal Cb/Cr, R is the reference color axis selected to be rotated, r′ is the rotated reference color axis, M and Y are the reference color axes at the two sides of the reference color axis selected to be rotated, Angle(Mr′) is the included angle between the reference color axis M and the reference color axis r′, Angle(RY) is the included angle between the reference color axis R and the reference color axis Y and Angle(r′Y) is the included angle between the reference color axis r′ and the reference color axis Y.

32. A method for adjusting colors in an input image, comprising:
receiving a first hue angle converted from the input image and a control signal;
generating a plurality of color areas with a plurality of reference color axes;
selecting one or more reference color axes to be rotated based on the control signal;
choosing one or more color areas next to the reference color axes to be rotated as an adjustment area, the rotated reference color axes falling in the adjustment area; and
performing operations on the first hue angle when falling in the adjustment area to obtain a second hue angle.

33. The method as recited in claim 32, wherein the step for obtaining the second hue angle comprises: using linear interpolation, linear extrapolation, quadratic equation, cubic equation or any combination thereof to obtain the second hue angle.

34. The method as recited in claim 33, wherein the step for choosing one or more color areas comprises choosing two color areas at two sides of each reference color axis and the step for obtaining the second hue angle uses linear extrapolation expressed as:
θ′=[θ/Angle(MR)]·Angle(Mr′) when the first hue angle falls in one color area at one side of the selected reference color axis; and
θ′=[θ/Angle(RY)]·Angle(r′Y) when the first hue angle falls in the other color area at the other side of the selected reference color axis,
where θ and θ′ are the first and second hue angles of the first chrominance signal Cb/Cr, R is the reference color axis selected to be rotated, r′ is the rotated reference color axis, M and Y are the reference color axes at the two sides of the reference color axis selected to be rotated, Angle(Mr′) is the included angle between the reference color axis M and the reference color axis r′, Angle(RY) is the included angle between the reference color axis R and the reference color axis Y and Angle(r′Y) is the included angle between the reference color axis r′ and the reference color axis Y.
